(19) United States
(12) Patent Application Publication
(10) Pub. No.: US 2022/0203821 A1
(43) Pub. Date: Jun. 30, 2022

(54) Transmission Device for a Hybrid Vehicle

(71) Applicant: ZF Friedrichshafen AG, Friedrichshafen (DE)

(72) Inventors: Fabian Kutter, Kressbronn (DE); Matthias Horn, Tettnang (DE); Johannes Kaltenbach, Friedrichshafen (DE); Stefan Beck, Eriskirch (DE); Thomas Martin, Weissensberg (DE); Uwe Griesmeier, Markdorf (DE)

(21) Appl. No.: 17/605,668

(22) PCT Filed: Mar. 4, 2020
(86) PCT No.: PCT/EP2020/055629

§ 371 Date: Oct. 22, 2021

(30) Foreign Application Priority Data
Apr. 23, 2019 (DE) 10 2019 205 749.7

(51) Int. Cl. B60K 6/405; B60K 6/26; B60K 6/365; B60K 6/24; B60K 6/547

(52) U.S. Cl. CPC B60K 6/405; B60K 6/26; B60K 6/547; B60K 6/24; B60K 6/365

(57) ABSTRACT

A transmission device for a hybrid vehicle having a drive train arranged transversely to a direction of travel of the hybrid vehicle includes a transmission housing having an engine-side housing section, a middle housing section, and a wheel-side housing section. The transmission further includes a first electric machine in the wheel-side housing section, a second electric machine in the middle housing section, an input shaft connectable to an internal combustion engine, and a differential gear connected to a first output shaft and a second output shaft. Additionally, the transmission includes a planetary transmission, and an intermediate shaft in a power flow between the planetary transmission and the differential gear. Particularly, the first electric machine is coaxial to the input shaft, and the second electric machine is axially parallel to the input shaft and connected to the input shaft via a chain drive or a spur gear drive.

### CROSS-REFERENCE TO RELATED APPLICATION

The present application is related and has right of priority to German Patent Application No. 10 2019 205 749.7 filed on Apr. 23, 2019 and is a nationalization of PCT/EP2020/055629 filed in the European Patent Office on Mar. 4, 2020, both of which are incorporated by reference in their entirety for all purposes.

### FIELD OF THE INVENTION

The invention relates generally to a transmission device for a hybrid vehicle having a first prime mover and a second prime mover. The invention further also relates to a drive device for a hybrid vehicle, including an internal combustion engine and a transmission device having a first prime mover and a second prime mover according to example aspects of the invention.

### BACKGROUND

For example, DE 10 2017 201 894 A1 discloses a configuration of a transmission for a hybrid vehicle having a drive train aligned transversely to the direction of travel of the hybrid vehicle. The transmission includes an input shaft, an intermediate shaft, a differential gear, and precisely one electric machine configured for driving the hybrid vehicle and including a rotary rotor and a rotationally fixed stator. The input shaft, the intermediate shaft, the differential gear, and the rotor of the electric machine have axes of rotation arranged axially parallel to one another. The input shaft forms a torque-transmitting interface to an internal combustion engine of the hybrid vehicle or is connected to such an interface via a clutch or via a free-wheel unit. The differential gear includes torque-transmitting interfaces to drive shafts connected to driving wheels of the hybrid vehicle. The transmission is configured for providing different transmission ratios between the input shaft and an output shaft arranged coaxially to the input shaft, where the torque is transmitted between the output shaft and the differential gear via the intermediate shaft. The rotor is permanently connected, via a constant transmission ratio, either to the input shaft or to a further shaft of the transmission, which contributes to the formation of the gear ratio of the transmission. The axis of rotation of the intermediate shaft is arranged spatially below, and the axis of rotation of the rotor is arranged spatially above a connecting line between the axis of rotation of the input shaft and the axis of rotation of the differential gear.

### SUMMARY OF THE INVENTION

The problem addressed by example aspects of the present invention is that of creating a compact transmission device having two electric machines for a hybrid vehicle.

According to example aspects of the invention, a transmission device for a hybrid vehicle having a drive train arranged transversely to the direction of travel of the hybrid vehicle includes a transmission housing, a first electric machine and a second electric machine, an input shaft operatively connected to an internal combustion engine, a differential gear operatively connected to a first output shaft and a second output shaft, and a planetary transmission. An intermediate shaft is operatively arranged in the power flow between the planetary transmission and the differential gear. The first electric machine is arranged coaxially to the input shaft, while the second electric machine is arranged axially parallel to the input shaft and is operatively connected to the input shaft via a chain or spur gear drive. The transmission housing has an engine-side housing section, a middle housing section, and a wheel-side housing section, where the first electric machine is arranged in the wheel-side housing section, and where the second electric machine is arranged in the middle housing section.

The transmission housing is, in particular, in one piece and is subdivided into the three housing sections or regions, including an engine-side housing section abutting the internal combustion engine and defining a first end surface of the transmission housing, a wheel-side housing section abutting a wheel of the hybrid vehicle and defining a second end surface of the transmission housing, and a middle housing section arranged axially between the engine-side housing section and the wheel-side housing section and being open toward both end surfaces.

Due to the arrangement, according to example aspects of the invention, of the two electric machines in the transmission housing, a high degree of compactness of the transmission device is achieved in both the axial direction and in the radial direction. The axial position of the first electric machine in the transmission housing is close to the wheel and, thereby, as far away as possible from the internal combustion engine. The second electric machine is arranged axially between the first electric machine and the internal combustion engine. The first electric machine extends circumferentially around an axial section of the input shaft. Preferably, a torque converter and/or a torsional vibration damper are/is arranged in the engine-side housing section.

In other words, according to example aspects of the invention, a transmission device having two electric machines for a hybrid vehicle including a drive train aligned transversely to its direction of travel is provided, particularly having a so-called “front-mounted transverse arrangement” or a “rear-mounted transverse arrangement.” The transmission device includes the two electric machines, each having a rotationally fixed stator and a rotary rotor as well as a rotor shaft rotationally fixed to the respective rotor.

The transmission device is configured for providing different transmission ratios between the input shaft and an output shaft of the planetary transmission arranged coaxially to the input shaft. The planetary transmission includes, for this purpose, for example, multiple planetary gear sets and multiple clutches and engagement devices interacting therewith. The torque applied at the output shaft of the planetary transmission is transmitted via the intermediate shaft to the differential gear. Consequently, the input shaft is operatively connected to the differential gear via the planetary transmission and the intermediate shaft, where the two output shafts of the differential gear are operatively connected to a particular wheel of the hybrid vehicle.

An operative connection is understood to mean that two elements are directly connected to each other, or are at least indirectly connected to each other via at least one further element arranged therebetween. For example, further shafts and/or gearwheels are operatively arranged between two shafts.

In particular, the chain drive includes a first sprocket and a second sprocket as well as a chain arranged therebetween. The chain is utilized for transmitting torque and rotational speed between the two sprockets. For this purpose, the first sprocket is operatively connected to the output shaft of the planetary transmission, and the second sprocket is operatively connected to the intermediate shaft. In one alternative exemplary embodiment, which has a spur gear drive instead of a chain drive, multiple spur gears, in particular three spur gears, are operatively connected to each other such that a torque and rotational speed transmission from the output shaft of the planetary transmission onto the intermediate shaft is implemented.

According to one example embodiment of the invention, the chain or spur gear drive is arranged in the middle housing section, wherein a rotor shaft of the second electric machine is arranged in the middle housing section and is formed axially in the direction of the engine-side housing section. In other words, the rotor shaft of the second electric machine extends axially toward the internal combustion engine, wherein the rotor shaft is arranged exclusively in the middle housing section. The rotor shaft of the second electric machine is operatively connected to the input shaft via the chain or spur gear drive. The chain or spur gear drive is therefore arranged, on the input side, at the input shaft axially ahead of the planetary transmission. Preferably, the chain or spur gear drive as well as the output of the planetary transmission are arranged on the same side of the planetary transmission.

According to one further example embodiment of the invention, the chain or spur gear drive is arranged in the wheel-side housing section, wherein a rotor shaft of the second electric machine is arranged radially adjacent to the first electric machine and is guided axially along the entire first electric machine. In other words, the rotor shaft of the second electric machine extends out of the middle housing section up to the wheel-side housing section. The rotor shaft of the second electric machine extends axially along the entire length of the first electric machine along a peripheral portion of the first electric machine. The rotor shaft of the second electric machine is operatively connected to an end section of the input shaft the chain or spur gear drive. Consequently, the chain or spur gear drive is arranged axially between the planetary transmission and an end-surface housing wall of the wheel-side housing section. In particular, the chain or spur gear drive and the output of the planetary transmission are arranged on different sides of the planetary transmission.

Preferably, the second electric machine abuts the first electric machine at the end surface, with a radial distance between the input shaft and an outer contour of the first electric machine being greater than a minimum radial distance between the input shaft and an outer contour of the second electric machine. The outer contour of the particular electric machine is understood, in particular, to be the outer circumference of the particular stator. Consequently, the two electric machines are arranged, with respect to the end surfaces, such that a radial superposition with the second electric machine arises in an end-surface section of the first electric machine. In particular, an outer circumference of the first electric machine or of the stator of the first electric machine is greater than a minimum distance of the second electric machine or of the stator of the second electric machine to the input shaft. A minimum distance is understood to be the smallest distance in the case of multiple radial distances.

Preferably, a first rotor shaft of the first electric machine rotates about a first axis of rotation, a second rotor shaft of the second electric machine rotates about a second axis of rotation, the intermediate shaft rotates about a third axis of rotation, and the two output shafts of the differential gear rotate about a fourth axis of rotation. The four axes of rotation are parallel to one another.

In particular, the differential gear is a bevel gear differential. The differential gear being a bevel gear differential enables a further increase of the degree of compactness of the transmission device.

According to one example embodiment, the second axis of rotation is arranged spatially above and spatially behind the first axis of rotation, the third axis of rotation and the fourth axis of rotation are arranged spatially below and spatially behind the first axis of rotation, and the third axis of rotation is arranged spatially below and spatially ahead of the fourth axis of rotation.

According to one example embodiment, the second axis of rotation is arranged spatially above and spatially ahead of the first axis of rotation, the third axis of rotation and the fourth axis of rotation are arranged spatially below and spatially behind the first axis of rotation, and the third axis of rotation is arranged spatially below and spatially ahead of the fourth axis of rotation.

According to one example embodiment, the second axis of rotation is arranged spatially above and spatially ahead of the first axis of rotation, the third axis of rotation is arranged spatially above and spatially behind the first axis of rotation, the fourth axis of rotation is arranged spatially below and spatially behind the first axis of rotation, and the third axis of rotation is arranged spatially above and spatially ahead of the fourth axis of rotation.

According to one example embodiment, the second axis of rotation is arranged spatially below and spatially ahead of the first axis of rotation, the third axis of rotation is arranged spatially above and spatially behind the first axis of rotation, the fourth axis of rotation is arranged spatially below and spatially behind the first axis of rotation, and the third axis of rotation is arranged spatially above and spatially ahead of the fourth axis of rotation.

Preferably, the intermediate shaft includes at least two gearwheels, where at least one first gearwheel of the at least two gearwheels intermeshes with a tooth system at an output shaft of the planetary transmission, at least a second gearwheel of the at least two gearwheels intermeshes with a tooth system at the differential gear, and the intermediate shaft is axially arranged in the middle housing section. In particular, the tooth system is formed at a differential cage of the differential gear.

For example, the planetary transmission is at least partially radially within the first electric machine. Consequently, the first electric machine is formed circumferentially around the planetary transmission. In particular, the planetary transmission extends at least partially axially outside of the first electric machine. The planetary transmission is formed coaxially to the first electric machine and to the input shaft.

According to one example embodiment, the planetary transmission includes at least two planetary gear sets, where a first planetary gear set of the at least two planetary gear sets has a first sun gear, a first ring gear, and multiple first planet gears rotatably mounted on a first planet carrier, and where a second planetary gear set of the at least two planetary gear sets has a second sun gear, a second ring gear, and multiple second planet gears rotatably mounted on a second planet carrier.

The invention further also relates to a drive device for a hybrid vehicle, including an internal combustion engine and a transmission device having two electric machines according to example aspects of the invention.

### BRIEF DESCRIPTION OF THE DRAWINGS

Exemplary embodiments of the invention are explained in greater detail in the following with reference to the seven drawings, in which:

FIG. 1 shows a schematic view of a first embodiment of a drive device including a transmission device according to example aspects of the invention;

FIG. 2 shows a schematic view of a second embodiment of the drive device including a transmission device according to example aspects of the invention;

FIG. 3 shows a schematic view of an example embodiment of a planetary transmission of the transmission device; and

FIGS. 4a-4d each show a side view for illustrating the arrangement of two electric machines, an intermediate shaft, and a differential gear in the transmission device.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

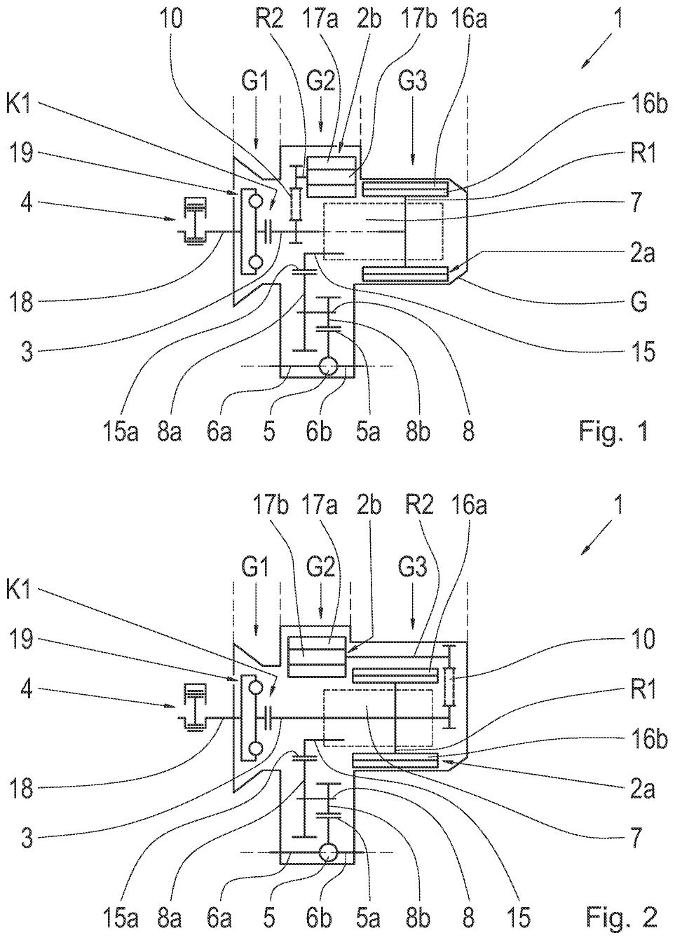

According to FIGS. 1 and 2, a particular drive device according to example aspects of the invention for a hybrid vehicle includes an internal combustion engine 4 and a transmission device 1 having a first electric machine 2a and a second electric machine 2b, where the electric machines 2a, 2b are arranged in a shared transmission housing G. The transmission housing G has an engine-side housing section G1, a middle housing section G2, and a wheel-side housing section G3. An axial length of the three housing sections G1, G2, G3 is represented by a total of four, vertical dashed lines. The first electric machine 2a is arranged in the wheel-side housing section G3 and, thereby, furthest from the internal combustion engine 4. In contrast, the second electric machine 2b is arranged in the middle housing section G2 and, thereby, axially between a torsional vibration damper 19 arranged in the engine-side housing section G1 and the first electric machine 2a.

The first electric machine 2a has a first rotationally fixed stator 16a, a first rotary rotor 16b, and a first rotor shaft R1 rotationally fixed to the first rotor 16b. Similarly, the second electric machine 2b has a second rotationally fixed stator 17a, a second rotary rotor 17b, and a second rotor shaft R2 rotationally fixed to the second rotor 17b. The second electric machine 2b is arranged adjacent to the first electric machine 2a at the end surface. A radial distance between an input shaft 3 of the transmission device 1 and an outer contour of the first electric machine 2a is greater than a radial distance between the input shaft 3 and an outer contour of the second electric machine 2b. As a result, the second electric machine 2b radially overlaps the first electric machine 2a, at least partially. The two electric machines 2a, 2b are, in fact, arranged axially very close to one another, but do not come to rest against one another. An axial air gap is formed between the two electric machines 2a, 2b.

The transmission device 1 is configured for a drive train arranged transversely to the direction of travel of the hybrid vehicle. In the present case, the input shaft 3 of the transmission device 1 is connectable via a first clutch K1 to the torsional vibration damper 19 and a crankshaft 18 of the internal combustion engine 4. The first clutch K1 has at least one disengaged engagement position and one engaged engagement position, wherein, when the first clutch K1 is in an engaged engagement position, the crankshaft 18 and the input shaft 3 are connected to each other in a rotationally fixed manner, and wherein, when the first clutch K1 is in a disengaged engagement position, the internal combustion engine 4 is decoupled from the transmission device 1.

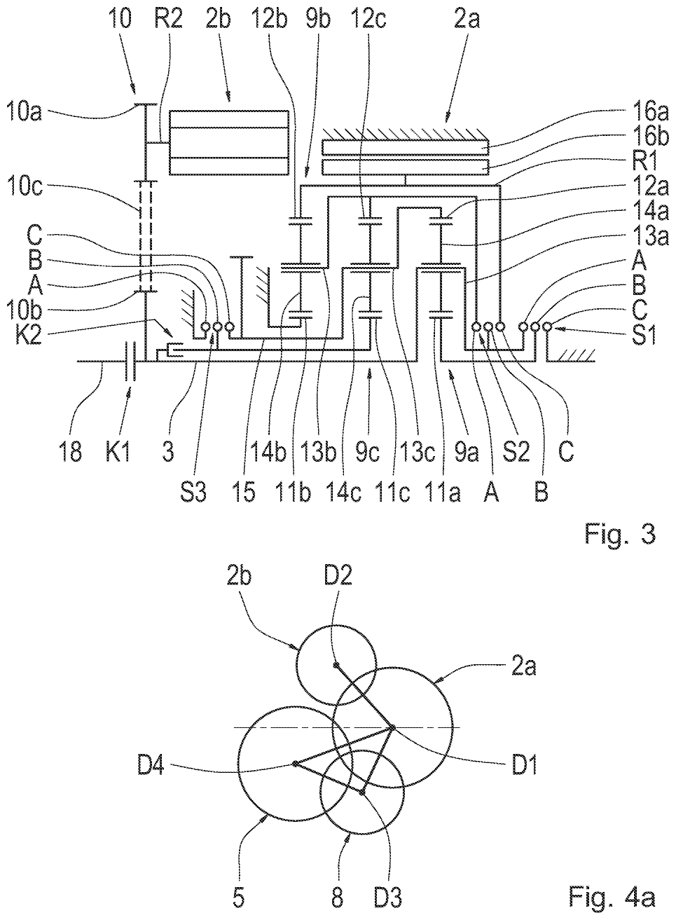

Moreover, the transmission device 1 includes a differential gear 5, where the differential gear 5 is operatively connected to a first output shaft 6a, a second output shaft 6b, and a planetary transmission 7, which is represented by a dashed-line rectangle in the present case and is not described in greater detail. An example embodiment of the planetary transmission 7 is represented in FIG. 3. The differential gear 5 is a bevel gear differential and is operatively connected to the first output shaft 6a and the second output shaft 6b. The particular output shaft 6a, 6b is operatively connected to a particular wheel of the hybrid vehicle.

An intermediate shaft 8 is operatively arranged in the power flow between the planetary transmission 7 and the differential gear 5. The intermediate shaft 8 includes a first gearwheel 8a and a second gearwheel 8b, wherein the first gearwheel 8a intermeshes with a tooth system 15a at an output shaft 15 of the planetary transmission 7, and wherein the second gearwheel 8b intermeshes with a tooth system 5a at the differential gear 5. The first gearwheel 8a has a larger diameter than the second gearwheel 8b. The two gearwheels 8a, 8b, by definition, are rotationally fixed to the intermediate shaft 8.

The planetary transmission 7, the differential gear 5, and the intermediate shaft 8 are axially parallel to one another. Moreover, the first electric machine 2a is arranged coaxially to the input shaft 3 and axially parallel to the second electric machine 2b.

In FIG. 1, the second electric machine 2b is operatively connected to the input shaft 3 via a chain or spur gear drive 10. The chain or spur gear drive 10 is arranged in the middle housing section G2. The rotor shaft R2 of the second electric machine 2b is arranged in the middle housing section G2 and is formed axially in the direction of the engine-side housing section G1. In the present case, the rotor shaft R2 of the second electric machine 2b is axially very short.

In FIG. 2, the second electric machine 2b is operatively connected to the input shaft 3 via a chain or spur gear drive 10, where the chain or spur gear drive 10 is arranged in the wheel-side housing section G3. The rotor shaft R2 of the second electric machine 2b is arranged radially adjacent to the first electric machine 2a and is guided axially along the entire axial length of the first electric machine 2a. Consequently, the rotor shaft R2 of the second electric machine 2b extends from the middle housing section G2 up to the end of the wheel-side housing section G3. Therefore, the rotor shaft R2 of the second electric machine 2b is axially longer than the axial length of the first electric machine 2a.

According to FIG. 3, the planetary transmission 7 includes a first planetary gear set 9a, a second planetary gear set 9b, and a third planetary gear set 9c. The planetary transmission 7 is arranged radially within the first electric machine 2a. The first planetary gear set 9a includes a first sun gear 11a, a first ring gear 12a, and multiple first planet gears 14a rotatably mounted on a first planet carrier 13a. The second planetary gear set 9b includes a second sun gear 11b, which is fixed to the housing, a second ring gear 12b, and multiple second planet gears 14b rotatably mounted on a second planet carrier 13b. Moreover, the third planetary gear set 9c includes a third sun gear 11c, a third ring gear 12c, and multiple third planet gears 14c rotatably mounted on a third planet carrier 13c.

The input shaft 3 is coupleable to the crankshaft 18 of the internal combustion engine 4 via the first clutch K1. The input shaft 3 is coupleable to the third sun gear 11c via a second clutch K2. Each respective clutch K1, K2 has at least one disengaged engagement position and one engaged engagement position. For example, when the first clutch K1 is in an engaged engagement position, the crankshaft 18 and the input shaft 3 are connected to each other in a rotationally fixed manner, and when the first clutch K1 is in a disengaged engagement position, the internal combustion engine 4 is decoupled from the transmission device 1. Similarly, when the second clutch K2 is in an engaged engagement position, the input shaft 3 and the third sun gear 11c are connected to each other in a rotationally fixed manner, and when the second clutch K2 is in a disengaged engagement position, the input shaft 3 and the third sun gear 11c are decoupled and, thereby, rotatable relative to one another.

Moreover, the input shaft 3 is rotationally fixed to the first planet carrier 13a. The second electric machine 2b is operatively connected to the input shaft 3 via a chain or spur gear drive 10. In the present case, the chain or spur gear drive 10 is a chain drive and is arranged in the power flow between the second electric machine 2b and the planetary transmission 7. The chain drive 10 includes a first sprocket 10a, a second sprocket 10b, and a chain 10c arranged therebetween, with the chain 10c being connected to the two sprockets 10a, 10b in order to transmit a rotational speed and a torque. The first sprocket 10a is rotationally fixed to the second rotor shaft R2 of the second electric machine 2b, and the second sprocket 10b is rotationally fixed to the input shaft 3.

The first sun gear 11a is rotationally fixed to the first planet carrier 13a and the input shaft 3 via a first engagement device S1 according to or in a first engagement position A, is freely rotatable via the first engagement device S1 in or according to a second, neutral engagement position B, and is fixed to the housing via the first engagement device S1 in or according to a third engagement position C.

Moreover, the input shaft 3 and the first planet carrier 13a are rotationally fixed to the third ring gear 12c and the second planet carrier 13b via a second engagement device S2 according to or in a first engagement position A, are freely rotatable via the second engagement device S2 according to or in a second, neutral engagement position B, and are rotationally fixed to the first rotor shaft R1 and the second ring gear 12b via the second engagement device S2 according to or in a third engagement position C.

Moreover, the third sun gear 11c is fixed to the housing via a third engagement device S3 according to or in a first engagement position A, is freely rotatable via the third engagement device S3 according to or in a second, neutral engagement position B, and is rotationally fixed to the third planet carrier 13c and the first ring gear 12a via the third engagement device S3 according to or in a third engagement position C. Moreover, the third planet carrier 13c is rotationally fixed to the output shaft 15 of the planetary transmission 7.

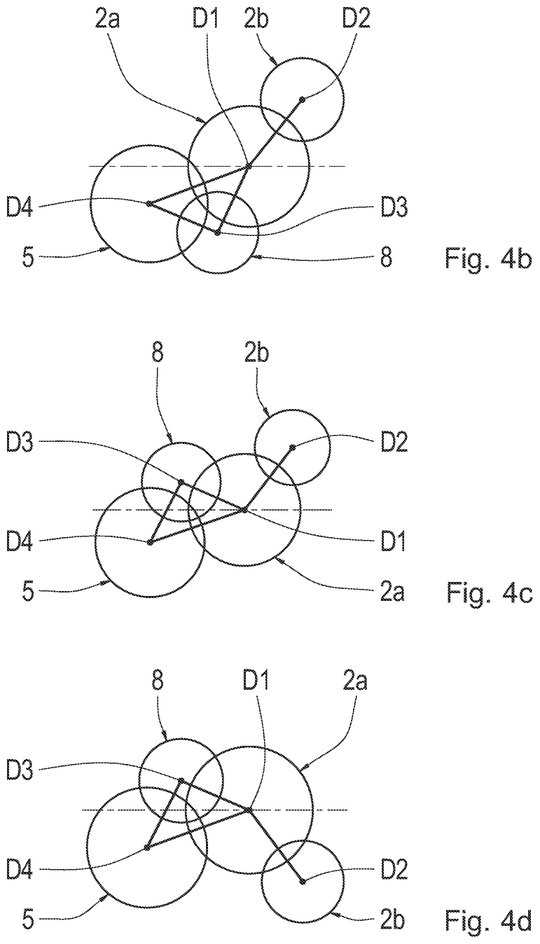

FIGS. 4a, 4b, 4c, and 4d each show a side view illustrating the arrangement of the two electric machines 2a, 2b, the intermediate shaft 8, and the differential gear 5 in the transmission device 1. The first electric machine 2a, together with the input shaft 3 (FIGS. 1-3) and the planetary transmission 7 (FIGS. 1-3), has a first axis of rotation D1. The second electric machine 2b has a second axis of rotation D2. Moreover, the intermediate shaft 8 has a third axis of rotation D3. Additionally, the differential gear 5 has a fourth axis of rotation D4. The four axes of rotation D1, D2, D3, D4 are arranged axially parallel to one another, transversely to the direction of travel of the hybrid vehicle, and spatially between two wheels of the hybrid vehicle. The following designations “spatially below” and “spatially above” as well as “spatially ahead of” and “spatially behind” relate to the installation position of the transmission arrangement 1 in the hybrid vehicle and, in fact, transversely to the direction of travel.

According to FIG. 4a, the second axis of rotation D2 is arranged spatially above and spatially behind the first axis of rotation D1. Moreover, the third axis of rotation D3 and the fourth axis of rotation D4 are arranged spatially below and spatially behind the first axis of rotation D1, with the third axis of rotation D3 being arranged spatially below and spatially ahead of the fourth axis of rotation D4.

According to FIG. 4b, the second axis of rotation D2 is arranged spatially above and spatially ahead of the first axis of rotation D1. Moreover, the third axis of rotation D3 and the fourth axis of rotation D4 are arranged spatially below and spatially behind the first axis of rotation D1, with the third axis of rotation D3 being arranged spatially below and spatially ahead of the fourth axis of rotation D4.

In FIG. 4c, the second axis of rotation D2 is arranged spatially above and spatially ahead of the first axis of rotation D1. Moreover, the third axis of rotation D3 is arranged spatially above and spatially behind the first axis of rotation D1, while the fourth axis of rotation D4 is arranged spatially below and spatially behind the first axis of rotation D1. Moreover, the third axis of rotation D3 is arranged spatially above and spatially ahead of the fourth axis of rotation D4.

In FIG. 4d, the second axis of rotation D2 is arranged spatially below and spatially ahead of the first axis of rotation D1. Moreover, the third axis of rotation D3 is arranged spatially above and spatially behind the first axis of rotation D1, while the fourth axis of rotation D4 is arranged spatially below and spatially behind the first axis of rotation D1. Moreover, the third axis of rotation D3 is arranged spatially above and spatially ahead of the fourth axis of rotation D4.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 transmission device
2a first electric machine
2b second electric machine
3 input shaft
4 internal combustion engine
5 differential gear
5a tooth system at the differential gear
6a first output shaft
6b second output shaft
7 planetary transmission
8 intermediate shaft
8a first gearwheel
8b second gearwheel
9a first planetary gear set
9b second planetary gear set
9c third planetary gear set
10 chain or spur gear drive
10a first sprocket
10b second sprocket
10c chain
11a first sun gear
11b second sun gear
11c third sun gear
12a first ring gear
12b second ring gear
12c third ring gear
13a first planet carrier
13b second planet carrier
13c third planet carrier
14a first planet gear
14b second planet gear
14c third planet gear
15 output shaft of the planetary transmission
15a tooth system at an output shaft
16a first stator
16b first rotor
17a second stator
17b second rotor
18 crankshaft
19 torsional vibration damper
A first engagement position
B second engagement position
C third engagement position
D1 first axis of rotation
D2 second axis of rotation
D3 third axis of rotation
D4 fourth axis of rotation
G transmission housing
G1 engine-side housing section
G2 middle housing section
G3 wheel-side housing section
K1 first clutch
K2 second clutch
R1 first rotor shaft
R2 second rotor shaft
S1 first engagement device
S2 second engagement device
S3 third engagement device

1-14: (canceled)

15. A transmission device (1) for a hybrid vehicle having a drive train arranged transversely to a direction of travel of the hybrid vehicle, comprising:
a transmission housing (G) having an engine-side housing section (G1), a middle housing section (G2), and a wheel-side housing section (G3);
a first electric machine (2a), the first electric machine (2a) being in the wheel-side housing section (G3);
a second electric machine (2b), the second electric machine (2b) being in the middle housing section (G2);
an input shaft (3) operatively connectable to an internal combustion engine (4);
a first output shaft (6a);
a second output shaft (6b);
a differential gear (5) operatively connected to the first output shaft (6a) and the second output shaft (6b);
a planetary transmission (7); and
an intermediate shaft (8) operatively arranged in a power flow between the planetary transmission (7) and the differential gear (5),
wherein the first electric machine (2a) is coaxial to the input shaft (3), and
wherein the second electric machine (2b) is axially parallel to the input shaft (3) and operatively connected to the input shaft (3) via one of a chain drive or a spur gear drive (10).

16. The transmission device (1) of claim 15, wherein the one of the chain drive or the spur gear drive (10) is in the middle housing section (G2), and
wherein a rotor shaft (R2) of the second electric machine (2b) is in the middle housing section (G2) and is axially closer to the engine-side housing section (G1).

17. The transmission device (1) of claim 15, wherein the one of the chain drive or the spur gear drive (10) is in the wheel-side housing section (G3), and
wherein a rotor shaft (R2) of the second electric machine (2b) is radially adjacent to the first electric machine (2a) and is formed axially along at least an entire axial length of the first electric machine (2a).

18. The transmission device (1) of claim 15, wherein the second electric machine (2b) abuts an end surface of the first electric machine (2a), and
wherein a radial distance between the input shaft (3) and an outer contour of the first electric machine (2a) is greater than a minimum radial distance between the input shaft (3) and an outer contour of the second electric machine (2b).

19. The transmission device (1) of claim 15, wherein the intermediate shaft (8) includes at least two gearwheels (8a, 8b),
wherein at least a first gearwheel (8a) of the at least two gearwheels (8a, 8b) intermeshes with a tooth system (15a) on an output shaft (15) of the planetary transmission (7),
wherein at least a second gearwheel (8b) of the at least two gearwheels (8a, 8b) intermeshes with a tooth system (5a) on the differential gear (5), and
wherein the intermediate shaft (8) is axially arranged in the middle housing section (G2).

20. The transmission device (1) of claim 15, wherein the planetary transmission (7) is at least partially radially within the first electric machine (2a).

21. The transmission device (1) of claim 15, wherein the planetary transmission (7) includes at least a first planetary gear set (9a) and a second planetary gear set (9b),
wherein the first planetary gear set (9a) has a first sun gear (11a), a first ring gear (12a), and multiple first planet gears (14a) rotatably mounted on a first planet carrier (13a), and
wherein the second planetary gear set (9b) has a second sun gear (11b), a second ring gear (12b), and multiple second planet gears (14b) rotatably mounted on a second planet carrier (13b).

22. The transmission device (1) of claim 15, wherein the differential gear (5) is a bevel gear differential.

23. The transmission device (1) of claim 15, wherein a first rotor shaft (R1) of the first electric machine (2a) rotates about a first axis of rotation (D1),
wherein a second rotor shaft (R2) of the second electric machine (2b) rotates about a second axis of rotation (D2),
wherein the intermediate shaft (8) rotates about a third axis of rotation (D3), and
wherein the first and second output shafts (6a, 6b) of the differential gear (5) rotate about a fourth axis of rotation (D4).

24. The transmission device (1) of claim 23, wherein the second axis of rotation (D2) is arranged spatially above and spatially behind the first axis of rotation (D1),
wherein the third axis of rotation (D3) and the fourth axis of rotation (D4) are arranged spatially below and spatially behind the first axis of rotation (D1), and
wherein the third axis of rotation (D3) is arranged spatially below and spatially ahead of the fourth axis of rotation (D4).

25. The transmission device (1) of claim 23, wherein the second axis of rotation (D2) is arranged spatially above and spatially ahead of the first axis of rotation (D1),
wherein the third axis of rotation (D3) and the fourth axis of rotation (D4) are arranged spatially below and spatially behind the first axis of rotation (D1), and
wherein the third axis of rotation (D3) is arranged spatially below and spatially ahead of the fourth axis of rotation (D4).

26. The transmission device (1) of claim 23, wherein the second axis of rotation (D2) is arranged spatially above and spatially ahead of the first axis of rotation (D1),
wherein the third axis of rotation (D3) is arranged spatially above and spatially behind the first axis of rotation (D1),
wherein the fourth axis of rotation (D4) is arranged spatially below and spatially behind the first axis of rotation (D1), and
wherein the third axis of rotation (D3) is arranged spatially above and spatially ahead of the fourth axis of rotation (D4).

27. The transmission device (1) of claim 23, wherein the second axis of rotation (D2) is arranged spatially below and spatially ahead of the first axis of rotation (D1),
wherein the third axis of rotation (D3) is arranged spatially above and spatially behind the first axis of rotation (D1),
wherein the fourth axis of rotation (D4) is arranged spatially below and spatially behind the first axis of rotation (D1), and
wherein the third axis of rotation (D3) is arranged spatially above and spatially ahead of the fourth axis of rotation (D4).

28. A drive device for a hybrid vehicle, comprising an internal combustion engine (4) and the transmission device (1) of claim 15.
